(19) United States
(12) Patent Application Publication
(10) Pub. No.: US 2023/0331551 A1
(43) Pub. Date: Oct. 19, 2023

(54) HIGH PRESSURE DESORPTION OF HYDROGEN CHLORIDE GAS

(71) Applicant: SGL CARBON SE, Wiesbaden (DE)

(72) Inventors: Christian WOLTZ, Meitingen (DE); Kenneth CHULACK, Meitingen (DE); Odon ANGELES, Meitingen (DE)

(73) Assignee: SGL CARBON SE, Wiesbaden (DE)

(21) Appl. No.: 18/006,457

(22) PCT Filed: Jul. 20, 2021
(86) PCT No.: PCT/EP2021/070251

§ 371 Date: Jan. 23, 2023

Related U.S. Application Data
(60) Provisional application No. 63/054,901, filed on Jul. 22, 2020.

(30) Foreign Application Priority Data
Aug. 4, 2020 (DE) 10 2020 209 812.3

(51) Int. Cl. C01B 7/07; B01D 3/06

(52) U.S. Cl. CPC C01B 7/0706; B01D 3/06; C01B 2210/0025

(57) ABSTRACT

A method for producing a hydrogen chloride. A pressurized highly concentrated hydrochloric acid having a hydrogen chloride concentration of 35% by weight or above is fed into a high pressure desorption device, the high pressure desorption device is operated at a pressure P_{des} of 2 bar or above and at a temperature T from 110 to 200° C. in the bottom of the high pressure desorption device, and the hydrogen chloride is desorbed in the high pressure desorption device.

### FIELD

The present invention relates to a method and a unit for producing a hydrogen chloride (HCI), and to a set of parts for constructing a unit of the invention.

### BACKGROUND

In many processes, HCI gas or hydrochloric acids containing different kinds and amounts of impurities are produced as side product or waste streams. Different treatment technologies were developed for recovering HCI from such side product or waste streams.

German Utility model DE 20 2020 101 571 U1 describes a method for recovering HCI from a hydrochloric acid contaminated with salts of aluminum or other metals. Such (waste) liquids can be formed in the treatment of specific ores with HCI. According to DE 20 2020 101 571 U1, the contaminated hydrochloric acid is vaporized, and the HCI-containing vapors are fed into a pressure swing distillation. The head product of the column operated at higher pressure is rich in HCI. It may contain more than 90% HCI and it is sufficiently pure for recycling it into an upstream ore treatment step.

GB 669,671 tries to a obtain from aqueous hydrochloric acid solutions a hydrogen chloride gas containing more than 99% hydrogen chloride by weight or even less than 0.03% water by weight. For this purpose, the document describes feeding an aqueous hydrochloric acid containing more HCI than an azeotropic mixture of HCI and water into an upper section of a column, while a hot hygroscopic salt solution is fed into an intermediate section of the column. Exit vapors containing HCI and moisture leave the column at the top. GB 669,671 further teaches that the water content of the HCI exit vapors is reduced to less than 0.03% by weight by passing the vapors through a water-cooled condenser, a refrigerated aftercooler, and finally through a mist separator.

European Patent No. 2909132 describes a method for concentrating a hydrochloric acid, which comprises an extractive distillation of an aqueous hydrogen chloride starting solution in the presence of an extraction agent, e.g., sulfuric acid, magnesium chloride, and/or calcium chloride, in a distillation device, and withdrawing hydrogen chloride vapor and/or hydrogen chloride gas from the upper portion of the distillation device. The patent describes that water can be removed from the hydrogen chloride gas obtained from the upper portion of the distillation device by condensation.

HCI obtained from such processes is not always sufficiently pure and at a physical state (at high density, e.g. compressed or even liquefied) desired for delivery to particularly demanding applications. Such particularly demanding applications involve the production of semiconductors, where “electronic grade HCI” is used as an etching gas, cleaning gas, or as a film forming gas.

There have been different attempts for providing HCI at a purity and physical state (under high pressure or liquefied) desired for such applications. EP 3336056 A1 and EP 3336057 A1, for example, teach two very different methods for forming such HCI. In addition to upstream processing steps, both methods involve the formation of a condensed (liquefied) HCI by compression with a compressor. EP 3336057 A1 specifically describes compressing and liquefying a dehydrated crude hydrogen chloride, for example, at the pressure of 2.6 MPa (absolute pressure) or more in case of approximately 0° C. According to the methods described in EP 3336056 A1 and EP 3336057 A1, the liquefied HCI must be purified further by distillation. EP 3336057 A1 teaches that a rectification apparatus (distillation tower) such as a tray tower or a packed tower is preferably used for the distillation.

Compressors cannot be made exclusively from (graphite based) materials which are not corroded by HCI. An HCI gas which is compressed in a compressor therefore is always contaminated to a certain extent by metals or other non-HCI-resistant materials of the compressor. HCI extracts these metals or other non-HCI-resistant materials from the compressor. Compressors which are used for the compression of HCI need much maintenance. This appears to be due to HCI corrosive attack on compressors. In this regard, methods involving much HCI gas compression, such as those described in EP 3336056 A1 and EP 3336057 A1 have disadvantages and part of the purification achieved in the rectification apparatus appears to be necessary for removing contaminants from the upstream compressor. It further appears that there is little room for improving the compressors towards higher HCI stability and lower maintenance necessities.

The problem underlying the invention is the provision of a reliable and efficient method and unit for producing a hydrogen chloride with minimum risk of contamination for demanding applications such as e.g. electronic grade HCI.

### SUMMARY

This problem is solved by a method for producing a hydrogen chloride, wherein a pressurized highly concentrated hydrochloric acid having a hydrogen chloride concentration of 35% by weight or above is fed into a high pressure desorption device, the high pressure desorption device is operated at a pressure P_{des} of 2 bar or above and at a temperature T from 110 to 200° C. in the bottom of the high pressure desorption device, and the hydrogen chloride is desorbed in the high pressure desorption device.

According to the invention, the desorbed hydrogen chloride is automatically obtained at high pressure P_{des} and does not contain any of the (non-volatile) contaminants originating from compression of HCI in a compressor. Therefore, downstream compression of the hydrogen chloride can be partially or fully avoided. Initial compression stages, i.e. those compression stages that are due to the high initial HCI gas volumes larger than downstream compression stages, can be fully avoided. Less compression stages result in even purer hydrogen chloride as compared to a hydrogen chloride which is brought to its compressed state by compressors only. The hydrogen chloride produced according to the method of the invention is pure because the method can be carried out with particularly corrosion stable materials at relatively low temperatures. The introduction of, e.g. metallic contaminants is inherently lower than in methods that employ more HCI gas compression.

Reliability and efficiency are increased because the pressure can be increased in the liquid highly concentrated hydrochloric acid with a pump (e.g. a centrifugal pump), instead of increasing the pressure of the hydrogen chloride gas by compressing it in a compressor. Hydrochloric acid pumps are much more reliable than hydrogen chloride gas compressors. This also results in higher efficiency as frequent maintenance of brittle HCI gas compressor(s) is avoided at least in part.

As the hydrogen chloride is desorbed in the high pressure desorption device, the hydrogen chloride produced according to the invention is a gas when it leaves the high pressure desorption device. This gas may contain droplets of entrained liquid. After the hydrogen chloride gas has left the high pressure desorption device, it can, for example, be converted into liquid hydrogen chloride. However, the hydrogen chloride will often be kept in a gaseous state and fed into hydrogen chloride gas consuming processes, depending on a customer’s needs and the specific processes operated on the customers site. According to the invention, P_{des} can be adapted in a broad range, depending on the hydrogen chloride compression desired by a customer. The invention is not limited with regard to the phase of the hydrogen chloride produced and the invention provided herein therefore refers to “a method for producing hydrogen chloride” without delimiting the invention with regard to the (gaseous, liquid or even solid) phase of hydrogen chloride.

According to the invention, the pressurized, highly concentrated hydrochloric acid that is fed into the high pressure desorption device has a hydrogen chloride concentration of 35% by weight or above. This means that 100 grams of this hydrochloric acid contain at least 35 grams of HCI. As is understood from FIGS. 3A and 3B below, such highly concentrated hydrochloric acids have low boiling points even at elevated pressures. This facilitates HCI desorption. The highly concentrated hydrochloric acid can, for example, have a hydrogen chloride concentration of 40 to 60% by weight. This allows operation at lower temperature and therefore avoids equipment issues. Lifetime of corrosion stable (graphite based) equipment within the high pressure desorption device is extended, as temperatures within the device do not approach dangerous temperatures (which are for resin impregnated graphite equipment close to 200° C.). The use of such hydrogen chloride concentration thus translates into longer equipment life, more reliable equipment design and less down times of the unit including the high pressure desorption device. Preferably, the highly concentrated hydrochloric acid has a hydrogen chloride concentration of 40 to 58% by weight, more preferably 40 to 56% by weight, most preferably 40 to 55% by weight.

Any pressure P_{des} of 2 bar or above is suitable for the invention as it inevitably results in a pressurized desorbed hydrogen chloride product that is denser and occupies less volume than a non-pressurized hydrogen chloride product. P_{des} can be 3 bar or above, preferably 4 bar or above, e.g. 5 bar or above. Such high P_{des} implies that the desorbed hydrogen chloride having about the same pressure is produced by the high pressure desorption device. Operation at such high P_{des} therefore is an elegant way to provide HCI at a high pressure required at a production site without or with less downstream compressing. Compressors for HCI gas fail frequently and require significant maintenance, which can be avoided by the invention. P_{des} can, for example, be in a range from 6 bar to 20 bar, preferably in a range from 6 bar to 15 bar, most preferably in a range from 6 bar to 13 bar. A particularly preferred pressure P_{des} is 10 bar.

All pressures mentioned herein are absolute pressures.

According to the invention, the desorption device is operated at a temperature T from 110 to 200° C. in the bottom of the high pressure desorption device. Within this temperature range, it is indeed possible to desorb hydrogen chloride from the highly concentrated hydrochloric acid fed into the high pressure desorption device. It is immediately apparent to those skilled in the art that lower temperatures of only 110° C. or slightly above are sufficient when the highly concentrated hydrochloric acid is very rich in HCI and the high pressure desorption device is operated at lower pressure. Higher temperatures of 200° C. or slightly below are chosen preferably when the highly concentrated hydrochloric acid is less rich in HCI and the high pressure desorption device is operated at higher pressure. The temperature T is preferably in a range from 120 to 175° C., e.g., 120 to 165° C. This results in longer lifetime of corrosion stable equipment and better reliability. As a consequence, many downtimes for maintenance of the high pressure desorption device can be avoided and the overall reliability and efficiency of the method of the invention can thus be increased further.

The method as described above can be implemented at any site where a pressurized, highly concentrated hydrochloric acid as defined herein, is available.

At many sites, such pressurized, highly concentrated hydrochloric acid will not be available. The present invention therefore includes optional upstream processing technology for forming the pressurized, highly concentrated hydrochloric acid from less concentrated hydrochloric acids that are generated at many different sites and cannot be emitted from the sites for ecological reasons.

At least part of the highly concentrated hydrochloric acid can be formed in an absorption device, in which a hydrogen chloride containing gas is absorbed into a less concentrated hydrochloric acid. This allows operation of the high pressure desorption device described herein at any site where a hydrogen chloride containing gas (e.g. waste gas) and a hydrochloric acid are available that are overall sufficiently rich in HCI for enriching the hydrochloric acid to an HCI concentration of at least 35% by weight.

Typically, the absorption device is operated at a pressure P_{abs} which is lower than P_{des}. P_{abs} can be in a range from 1 bar to 10 bar, e.g. 2.5 bar to 7.5 bar. The pressure P_{des} can, for example, be at least 1 bar, preferably at least 1.5 bar, most preferably at least 2 bar, e.g. at least 2.5 bar higher than P_{abs}. The Pressure P_{des} can in particular be 1 to 15 bar, preferably 1.5 to 13 bar, most preferably 2 to 11 bar, e.g. 2.5 bar to 10 bar higher than P_{abs}.

At many sites, only (liquid) hydrochloric acid (waste) streams are available and must be treated, but no hydrogen chloride containing gases are available. In order to make the invention also applicable at such sites, preferred methods of the invention include a generation of such hydrogen chloride containing gas. Accordingly, in a preferred method of the invention, at least part of the hydrogen chloride containing gas, that is absorbed into the less concentrated hydrochloric acid, is formed in a low pressure desorption device.

The word “low” in “low pressure desorption device” is used in order to make clear the this desorption device is operated at lower pressure than the high pressure desorption device. Pressure in the low pressure desorption device is typically slightly above the pressure in the absorption device in order to ensure that no compressor is required for directing the hydrogen chloride containing gas from the low pressure desorption device into the absorption device.

The low pressure desorption device can be fed with any sufficiently concentrated hydrochloric acid. According to a preferred method of the invention, at least part of a liquid obtained in the bottom of the high pressure desorption device is recycled into the low pressure desorption device. It has been found that the HCI concentration in the liquid obtained in the bottom of the high pressure desorption device is still high enough for desorbing at lower pressure in the low pressure desorption device a sufficiently rich hydrogen chloride containing gas which is well suited for enriching common hydrochloric acid (waste) streams that are available at many sites in the absorber.

The invention also relates to a unit for producing a hydrogen chloride, comprising
a high pressure desorption device for desorbing a hydrogen chloride from a pressurized highly concentrated hydrochloric acid, wherein the high pressure desorption device comprises a high pressure inlet for feeding a pressurized highly concentrated hydrochloric acid into the high pressure desorption device, an upper high pressure outlet for a hydrogen chloride which can be desorbed in the high pressure desorption device, and a lower high pressure outlet for a liquid obtainable in the bottom of the high pressure desorption device;
and a subunit which is connected to the high pressure inlet and to the lower high pressure outlet and which is capable of regenerating at least part of the pressurized highly concentrated hydrochloric acid to be fed via the high pressure inlet from at least part of the liquid obtainable through the lower high pressure outlet. All processing equipment shown on the left of the high pressure desorption device in FIG. 2 forms an example of such subunit. However, any other processing equipment connected to the high pressure inlet and to the lower high pressure outlet and which is capable of regenerating at least part of the pressurized highly concentrated hydrochloric acid to be fed via inlet from at least part of the liquid obtainable through the lower high pressure outlet is a suitable subunit.

According to the invention, the high pressure desorption device can preferably be operated at a pressure exceeding the pressure in the surrounding atmosphere by at least 5 bar, more preferably by at least 6 bar, e.g. by at least 7 bar.

The high pressure desorption device is preferably a high pressure desorption column.

The interior of the high pressure desorption device is typically corrosion resistant against pressurized highly concentrated hydrochloric acids having a hydrogen chloride concentration of at least 35% by weight at a temperature of 110° C. Those skilled in the art know that such corrosion resistance can, for example, be reached by using PTFE lined columns with graphite or carbon internals, as sold by SGL under the name Polyfluoron®. It is also possible to use a tantalum or tantalum lined column, in particular for a small pilot plant.

A preferred unit or method of the invention comprises a pump, wherein the pump is capable of feeding the highly concentrated hydrochloric acid against the high backpressure from the high pressure desorption device being under a pressure of at least 2 bar, in particular at least 6 bar, in the high pressure desorption device. The pump is typically a centrifugal corrosion-resistant pump, feeding the highly concentrated hydrochloric acid into the high pressure desorption device. The pump replaces a first or multiple stages of a downstream hydrogen chloride compression unit. This is advantageous as the pump is much smaller and requires less maintenance than compressors. This contributes to higher process efficiency because many downtimes of the unit of the invention can be avoided. Particular units of the invention do not comprise a compressor for compressing a HCI containing gas. Particular methods of the invention do not comprise compression of HCI containing gas. A particularly preferred unit and method of the invention does not comprise a compressor for maintaining a high pressure P_{des} of at least 2 bar, preferably at least 6 bar in the high pressure desorption device.

Furthermore, the invention relates to a hydrogen chloride supplying unit, comprising a high pressure desorption device for desorbing a hydrogen chloride from a pressurized highly concentrated hydrochloric acid, wherein the high pressure desorption device comprises a high pressure inlet for feeding a pressurized highly concentrated hydrochloric acid into the high pressure desorption device, an upper high pressure outlet for a hydrogen chloride which can be desorbed in the high pressure desorption device, and a lower high pressure outlet for a liquid obtainable in the bottom of the high pressure desorption device; and a hydrogen chloride filling device which is connected to the upper high pressure outlet.

The term “hydrogen chloride filling device” includes any device which is capable of separating a (continuous) hydrogen chloride fluid stream (which may be in a liquid or gaseous state) into defined, spatially separated quantities of hydrogen chloride fluid which can be filled into suitable tube trailers, ton containers, or cylinders, such as those in which different grades of liquefied hydrogen chloride gas are offered by different suppliers including BOC, Linde and Praxair.

The hydrogen chloride filling device can, for example, be connected to the upper high pressure outlet such that hydrogen chloride passing the high pressure outlet is directed into a high pressure condenser, from the high pressure condenser into a high pressure demister, and from the high pressure demister into the hydrogen chloride filling device. If P_{des} is high, even liquefied hydrogen chloride can be obtained by cooling (and condensing), i.e. with reduced effort for hydrogen chloride gas compression. The hydrogen chloride filling device can, for example, be connected to the upper high pressure outlet such that hydrogen chloride passing the high pressure outlet is directed into a hydrogen chloride cleaning and liquefying unit, and from the hydrogen chloride cleaning and liquefying unit into the hydrogen chloride filling device. Any unit that reduces the content of an impurity in the hydrogen chloride is considered a hydrogen chloride cleaning unit. It is apparent for a skilled person that suitable equipment for such hydrogen chloride cleaning and liquefying units is described, for example, in EP 3336056 A1 and EP 3336057 A1. A skilled person can design the hydrogen chloride cleaning unit such that the hydrogen chloride to be filled in the filling device meets the specifications that are desired by a customer.

The invention also relates to a set of parts for constructing a unit of the intention, wherein the set comprises a high pressure desorption device for desorbing a hydrogen chloride gas from a pressurized highly concentrated hydrochloric acid, wherein the desorption device comprises
a high pressure inlet for feeding a pressurized highly concentrated hydrochloric acid into the high pressure desorption device,
an upper high pressure outlet for a hydrogen chloride gas which can be desorbed in the high pressure desorption device, and
a lower high pressure outlet for a liquid obtainable in the bottom of the high pressure desorption device;
   and an absorption device comprising an outlet for highly concentrated hydrochloric acid;
   and wherein the set is designed for connecting the outlet for highly concentrated hydrochloric acid in such a way via a pump with the high pressure inlet, that a highly concentrated hydrochloric acid from the upper high pressure outlet can be pressurized and fed via the high pressure inlet into the high pressure desorption device.

The set may further comprise a low pressure desorption device comprising an inlet for a liquid and the set is preferably designed for connecting the inlet for the liquid with the lower high pressure outlet such that at least part of a liquid obtained in the bottom of the high pressure desorption device can be recycled via the inlet for the liquid into the low pressure desorption device.

Any feature described herein in connection with (a) the method or (b) the unit for producing a hydrogen chloride of the invention or in connection with (c) the hydrogen chloride supplying unit of the invention or in connection with (d) the set of parts of the invention is not limited thereto. A feature described in connection with any of (a), (b), (c) or (d) can be a feature of any other of (a), (b), (c) or (d).

### BRIEF DESCRIPTION OF THE FIGURES

The invention is illustrated with reference to the figures described in the following. The figures are for illustration only and do not limit the scope of the claims.

FIG. 1: simplified process flow diagram of a high pressure desorption device suitable for a method of the invention;

FIG. 2: simplified process flow diagram of a unit according to the invention;

FIG. 3A: graphs showing the boiling points at different hydrochloric acid concentrations (low concentration range); and

FIG. 3B: graphs showing the boiling points at different hydrochloric acid concentrations (high concentration range).

### DETAILED DESCRIPTION

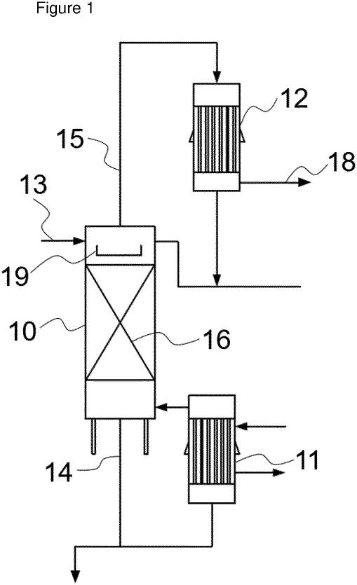

The high pressure desorption device 10 shown in FIG. 1 is a high pressure PTFE lined desorption column comprising a high pressure inlet 13 for feeding a pressurized highly concentrated hydrochloric acid into device 10, a lower high pressure outlet 14 for a liquid obtainable in the bottom of device 10, and an upper high pressure outlet 15 for a hydrogen chloride gas which can be desorbed in device 10. The bottom is heated by high pressure reboiler 11. Water contained by the desorbed hydrogen chloride gas, which leaves the device via outlet 15 is condensed in high pressure condenser 12. The cooled hydrogen chloride gas leaves condenser 12 via line 18 while the condensed liquid is recycled into device 10. Although not all details are shown, FIG. 1 further indicates that the desorption device may contain column internals 16 (e.g. made of graphite or CFRC or CFRP (Sigrabond® Chemical product lines sold by SGL) and a liquid distributor 19. FIG. 1 is also simplified in that it does not show the means that confer the column’s high pressure and corrosion stability. The column can be operated for a long time at high bottom temperature T of 110 to 200° C. and at high pressure P_{des} of up to 20 bar even when very corrosive pressurized and highly concentrated hydrochloric acid is fed into the column via inlet 13. It is therefore quite possible to carry out the method of the invention in the device as shown in FIG. 1.

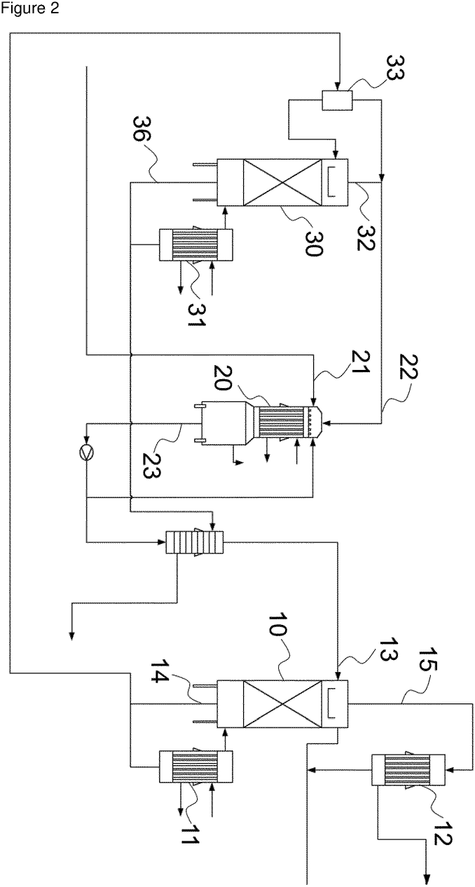

FIG. 2 shows the high pressure desorption device 10 (as shown in FIG. 1) as a part of a unit according to the invention. This unit further comprises an absorption device 20 and a low pressure desorption device 30.

Absorption device 20 comprises a feed 21 for a less concentrated hydrochloric acid, an inlet 22 for a hydrogen chloride containing gas and an outlet 23 for the highly concentrated hydrochloric acid. The highly concentrated hydrochloric acid can be formed in the absorption device 20, in which hydrogen chloride containing gas fed via inlet 22 is absorbed into a less concentrated hydrochloric acid. After the highly concentrated hydrochloric acid has left the absorption device through outlet 23, it is pumped in order to transport the highly concentrated hydrochloric acid against the high pressure P_{des} and preheated in a heat exchanger before it is fed via inlet 13 into the high pressure desorption device 10.

Low pressure desorption device 30 is preferably a desorption column and comprises a low pressure reboiler 31, a hydrogen chloride containing gas head product outlet 32, and a low pressure sump outlet 36. Low pressure desorption device 30 is further equipped with a flash vessel 33. Part of the liquid obtained in the bottom of the high pressure desorption device 10 is recycled via flash vessel 33 into the low pressure desorption device 30. In low pressure desorption device 30, the hydrogen chloride containing gas is formed and passed through gas head product outlet 32. The vapors formed in flash vessel 33 are fed into the hydrogen chloride containing gas and the hydrogen chloride containing gas is then fed via inlet 22 into absorption device 20. The bottoms are passed through outlet 36 and excess heat can be transferred from the bottoms in a heat exchanger to the pressurized highly concentrated hydrochloric acid, before the pressurized highly concentrated hydrochloric acid is fed via inlet 13 into device 10. “Low pressure” when used in connection with device 30 refers to a lower pressure as compared to the pressure in device 10. Nevertheless, the pressure in the low pressure desorption device 30 is typically well above the surrounding atmospheric pressure.

It is apparent that the low pressure desorption device and the absorption device as shown in FIG. 2 together can be considered as a subunit which is connected to the high pressure inlet 13 and to the lower high pressure outlet 14 and which is capable of regenerating at least part of the pressurized highly concentrated hydrochloric acid to be fed via inlet 13 from at least part of the liquid obtainable through outlet 14.

For carrying out a method of the invention, the unit as described in FIG. 2 can be operated, for example, under the following conditions:

Composition of feed 21: Hydrochloric acid (33% by weight of HCI in water)

The following table provides example parameters for operating devices 10, 20, and 30

| | Temperature [°C] | | P [bar] | HCI content in the bottom [% by weight] |
|---|---|---|---|---|
| | head | bottom | | |
| high pressure desorption device 10: | 73 | 144 | 11 (P_{des}) | 33 |
| absorption device 20: | 40 | | 5 | 43 |
| | | | (P_{abs}) | |
| low pressure desorption device 30: | 140 | 158 | 5 | 18 |

The pump is capable of transporting the highly concentrated hydrochloric acid against the high pressure P_{des}.

The weak acid released via low pressure sump outlet 36 contains 18% by weight of HCI. This weak acid could be treated by breaking the azeotrope, e.g. with a solution of a hygroscopic salts, such as CaCl₂.

After removal of residual moisture from the hydrogen chloride gas released through outlet 15 by drying in high pressure condenser 12, it is possible to further remove residual droplets carried by the stream obtained from condenser 12 with a high pressure demister (not shown). This will result in very low residual water content.

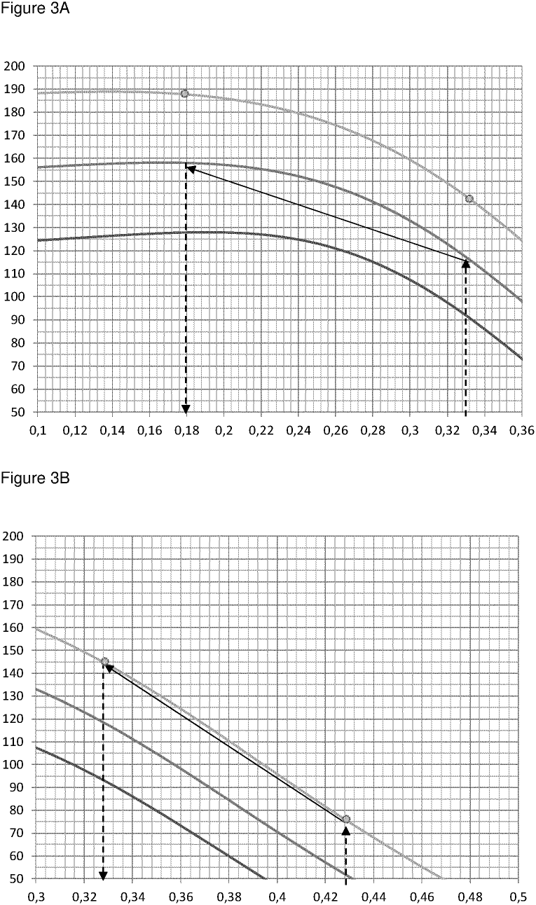

In FIGS. 3A and 3B, the boiling points in °C (vertical axis) are shown for different hydrogen chloride mass contents of the HCI / H₂O binary system (horizontal axis). The Figures show the boiling points at pressures of 2 bar (lower most curve), 5 bar (middle curve), 11 bar (top most curve). The arrows in FIGS. 3A, 3B refer to the thermal separation in low pressure desorption device 30 and high pressure desorption device 10, respectively. The arrows thus illustrate how the invention makes efficient use of a very sharp decline of boiling points of the HCI/H₂O binary system at hydrogen chloride mass contents above 0.35, i.e. at HCI concentrations above 35% by weight.

List of reference numerals

| | |
|---|---|
| high pressure desorption device | 10 |
| high pressure reboiler | 11 |
| high pressure condenser | 12 |
| column inlet for a pressurized highly concentrated hydrochloric acid | 13 |
| lower high pressure outlet | 14 |
| upper high pressure outlet | 15 |
| column internals | 16 |
| line for cooled hydrogen chloride gas | 18 |
| liquid distributor | 19 |
| absorption device | 20 |
| feed for less concentrated hydrochloric acid | 21 |
| inlet for hydrogen chloride containing gas | 22 |
| outlet for highly concentrated hydrochloric acid | 23 |
| low pressure desorption device | 30 |
| low pressure reboiler | 31 |
| hydrogen chloride containing gas head product outlet | 32 |
| flash vessel | 33 |
| low pressure sump outlet | 36 |

1-15. (canceled)

16. A method for producing a hydrogen chloride, comprising:
a pressurized highly concentrated hydrochloric acid having a hydrogen chloride concentration of 35% by weight or above is fed into a high pressure desorption device,
operating the high pressure desorption device at a pressure P_{des} of 2 bar or above and at a temperature T from 110 to 200° C. in the bottom of the high pressure desorption device, and
desorbing the hydrogen chloride in the high pressure desorption device.

17. The method according to claim 16, wherein the highly concentrated hydrochloric acid has a hydrogen chloride concentration of 40 to 60% by weight.

18. The method according to claim 16, wherein P_{des} is in a range from 6 bar to 20 bar.

19. The method according to claim 16, wherein the temperature T is in a range from 120 to 175° C.

20. The method according to claim 16, wherein at least part of the highly concentrated hydrochloric acid is formed in an absorption device, in which a hydrogen chloride containing gas is absorbed into a less concentrated hydrochloric acid.

21. The method according to claim 16, wherein the absorption device is operated at a pressure P_{abs} which is lower than P_{des}.

22. The method according to claim 20, wherein at least part of the hydrogen chloride containing gas that is absorbed into the less concentrated hydrochloric acid, is formed in a low pressure desorption device.

23. The method according to claim 22, wherein at least part of a liquid obtained in the bottom of the high pressure desorption device is recycled into the low pressure desorption device.

24. A unit for producing a hydrogen chloride, comprising
a high pressure desorption device for desorbing a hydrogen chloride from a pressurized highly concentrated hydrochloric acid, wherein the high pressure desorption device comprises
a high pressure inlet for feeding a pressurized highly concentrated hydrochloric acid into the high pressure desorption device,
an upper high pressure outlet for a hydrogen chloride which can be desorbed in the high pressure desorption device, and
a lower high pressure outlet for a liquid obtainable in the bottom of the high pressure desorption device;
and a subunit which is connected to the high pressure inlet and to the lower high pressure outlet and which is capable of regenerating at least part of the pressurized highly concentrated hydrochloric acid to be fed via the high pressure inlet from at least part of the liquid obtainable through the lower high pressure outlet.

25. The unit according to claim 24, wherein the high pressure desorption device can be operated at a pressure exceeding the pressure in the surrounding atmosphere by at least 5 bar.

26. The unit according to claim 24, wherein the interior of the high pressure desorption device is corrosion resistant against pressurized highly concentrated hydrochloric acids having a hydrogen chloride concentration of at least 35% by weight at a temperature of 110° C.

27. The unit according to claim 24, comprising a pump, wherein the pump is capable of feeding the highly concentrated hydrochloric acid against the high backpressure from the high pressure desorption device being under a pressure of at least 2 bar.

28. The unit according to claim 25, wherein the unit does not comprise a compressor for maintaining a high pressure P_{des} of at least 2 bar in the high pressure desorption device.

29. A hydrogen chloride supplying unit, comprising
a high pressure desorption device for desorbing a hydrogen chloride from a pressurized highly concentrated hydrochloric acid, wherein the high pressure desorption device comprises
a high pressure inlet for feeding a pressurized highly concentrated hydrochloric acid into the high pressure desorption device,
an upper high pressure outlet for a hydrogen chloride which can be desorbed in the high pressure desorption device, and
a lower high pressure outlet for a liquid obtainable in the bottom of the high pressure desorption device; and
a hydrogen chloride filling device which is connected to the upper high pressure outlet.

30. A system for constructing a unit according to claim 24, the system comprises
a high pressure desorption device for desorbing a hydrogen chloride gas from a pressurized highly concentrated hydrochloric acid, wherein the high pressure desorption device comprises
a high pressure inlet for feeding a pressurized highly concentrated hydrochloric acid into the high pressure desorption device,
an upper high pressure outlet for a hydrogen chloride gas which can be desorbed in the high pressure desorption device, and a lower high pressure outlet for a liquid obtainable in the bottom of the high pressure desorption device;
an absorption device comprising an outlet for highly concentrated hydrochloric acid;
wherein the system is designed for connecting the outlet for highly concentrated hydrochloric acid in such a way via a pump with the high pressure inlet, that a highly concentrated hydrochloric acid from outlet can be pressurized and fed via the high pressure inlet into the high pressure desorption device.
